(19) United States
(12) Patent Application Publication
(10) Pub. No.: US 2002/0047858 A1
(43) Pub. Date: Apr. 25, 2002

(54) Graphical user interfaces

(75) Inventors: Craig Andrew Bayliss, Christchurch (NZ); Joseph Michael Mahoney, Wellington (NZ)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 09/964,097

(22) Filed: Sep. 26, 2001

(30) Foreign Application Priority Data
Sep. 28, 2000 (NZ) 507,207

(51) Int. Cl. G06F 3/00

(52) U.S. Cl. 345/700

(57) ABSTRACT

This invention relates to a method of presenting a control on a computer user interface whereby information stored in a database 12 or the like is retrieved by a user. A GUI control is then selected which is suitable for displaying the information which has been retrieved. The GUI control is created and used to display the retrieved information on a user display 16.

### BACKGROUND TO THE INVENTION

1. Technical Field

This invention relates to user interfaces in a computer database system. In particular it relates to methods, software and computer readable medium for selecting and providing a graphical user interface which is suited to displaying information retrieved from a database. The selected user interface also enables further selection and manipulation of retrieved information.

2. Related Art

Database systems are used in a variety of applications to provide a user with access to stored information. Typically, such a system includes records which are stored and referenced in a particular manner for later retrieval via a client application. To retrieve information from the database the client application enables the user to specify certain criteria, for example by way of a structured query language (SQL) query. Information in the database which meets the specified criteria is then retrieved from the store and displayed to the user.

More recently due to the advent of graphical user displays the retrieved information, or data model, is rendered using one or more graphical user interface (GUI) controls. Rendering includes displaying information items on screen to a user and providing the user facilities to navigate the information and select one or some of the items. There are a variety of GUI control types all of which have different facilities for searching, displaying and/or selecting information items.

However, not all GUI controls are suited to displaying all data models. For example a large data model, i.e., a query result with a large amount of information, may be more conveniently rendered on one type of GUI control, while a smaller data model may be more suited to being rendered on another type of GUI control. However, the most suitable GUI control is not always used by a client application as it is specified by a programmer at design time. The requirements of a GUI control and the nature of the data model is not always known at design time, or may change thereafter.

For example as the number of records in the database increases over time, the data model for any one query will also grow. Further, queries are specified by the user and vary quite considerably, therefore making it difficult for a designer to predict the typical size or nature of a data model. Therefore, choosing an appropriate GUI control at design time for rendering a data model is not always possible.

It would therefore be desirable to have a system which selects at runtime an appropriate GUI control for rendering a retrieved data model.

### SUMMARY OF THE INVENTION

The present invention provides a method, software or computer readable medium containing instructions which renders information using a GUI control selected according to the nature of the information. Preferably, the information is retrieved from a database using a query or other suitable means. The information includes a set of records and the number of records in the set is determined. This number is compared to specified criteria and the result of the comparison is used to select an appropriate GUI control to display the information to the user and to provide other facilities for navigating, searching and/or selecting the records. Alternatively, another characteristic of the information may be used to select an appropriate GUI control.

One aspect of the present invention is directed to a method of presenting a control on a computer user interface comprising: retrieving stored information on request by a user; selecting a control according to the nature of the information; and creating the control on the interface including the information.

In another aspect of the present invention is provided a computer program product comprising a computer useable medium having computer readable program code embodied therein for presenting a control on a computer user interface, the program product comprising: program code configured to retrieve information requested by a user; program code configured to select a control according to the nature of the information; and program code configured to create the control on the interface including the information.

In another aspect of the present invention is provided a system for presenting a control on a computer user interface, the system comprising: means for retrieving information requested by a user; means for selecting a control according to the nature of the information; and means for creating the control on the interface including the information.

The invention may also broadly be said to include any alternative combination of features as described or shown in the accompanying drawings. Known equivalents of these features not expressly set out are nevertheless deemed to be included.

### BRIEF DESCRIPTION OF THE DRAWINGS

Preferred embodiments of the invention will be described with respect to the accompanying drawings, of which:

FIG. 1 schematically shows a client system implementing software for dynamically selecting and providing a graphical control suitable for displaying records retrieved from a database,

FIG. 2 schematically shows a generic control for a graphical user interface,

FIG. 3 outlines the function of a portion of a client application with a single threshold implemented on the system,

FIG. 4 schematically shows a portion of a preferred class structure for implementing the user interface generation software,

FIG. 5a is a screenshot of the RecordChooser control displaying a record selected using a control chosen by the software,

FIG. 5b is a screenshot showing a control, in this case a Combination box, suitable for displaying a small number of records retrieved from the database,

FIG. 5c is a screenshot showing a control, in this case a Pop-up List, suitable for displaying a larger number of records retrieved from the database,

FIG. 6 outlines the process for selecting a threshold value,

FIG. 7 is a screenshot showing a RecordChooser control and configuration tool provided by the graphical user interface design tool,

FIG. 8 outlines the function of a portion of a client application with multiple thresholds, and

FIG. 9 schematically shows hardware for implementing the invention.

### DETAILED DESCRIPTION OF THE INVENTION

Referring to the drawings it will be appreciated that software for selecting a GUI control according to the invention may be implemented in various forms. The following embodiments are given by way of example only. Details relating to the database itself and the software for performing standard database functions will be known to those skilled in this area of technology and will not be discussed in detail.

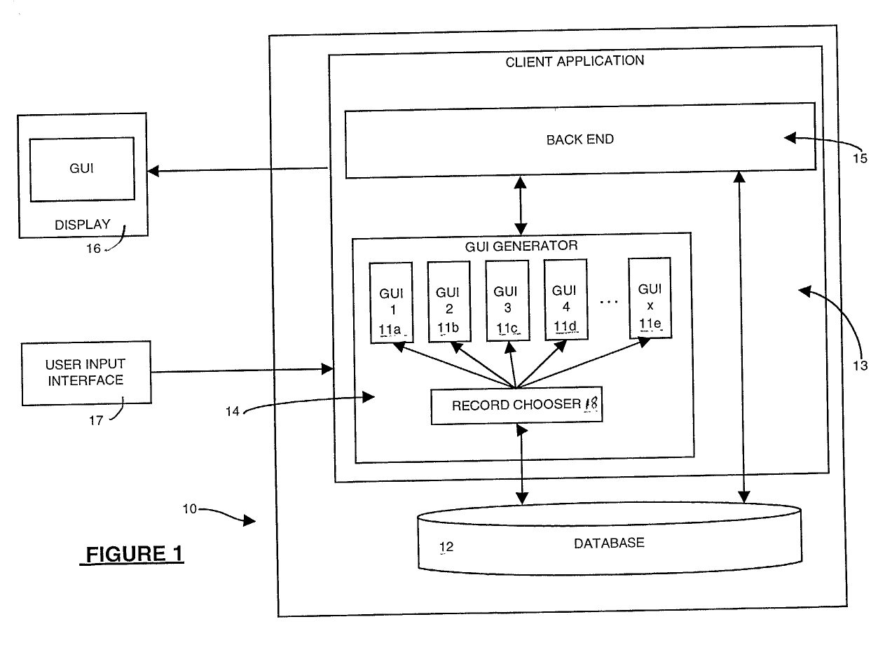

FIG. 1 shows a preferred embodiment of a database system 10 implementing a user interface to provide access to the contents of a database 12. System 10 enables a user to retrieve records or other information from database 12 using a query or the like, view the retrieved records and then select one or more of the records for subsequent use. The invention will typically be implemented in a client/server database system although it is not restricted to such use. The invention could also be implemented in a stand-alone database arrangement, for example.

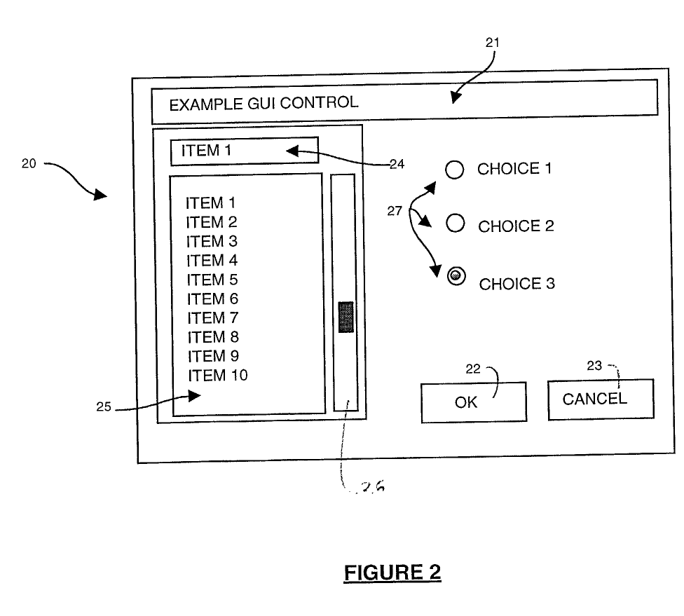

System 10 shown in FIG. 1 implements a client application 13 which includes a graphical user interface (GUI) generator 14. GUI generator 14 is adapted to create and display one of a plurality of GUI controls 11a-11e along with another control called a record chooser 18. Controls 11a-e and record chooser 18 are preferably implemented using an object oriented programming language such as JAVA™ or C++ although this is not essential. A functional language or any other suitable language type could be used instead. Controls are commonly used in computer applications to provide a graphical interface which enables use of the application. An example control 20 which could be used in a graphical user interface of a typical application is shown in FIG. 2. A control 20 can include a title bar 21, selection buttons 22, 23, a selection field 24, item display 25, scroll bar 26 and radio buttons 27.

Referring back to FIG. 1, client application 13 also includes back end software 15, which provides other functionality necessary for implementing database system 10 such as database search and information retrieval facilities. The details of the back end software 15 will be known to a person skilled in database design and need not be described here. System 10 also includes one or more monitors 16 or other display means for displaying a graphical user interface and a user input means 17 which can include a keyboard, mouse and any other required devices which will be well known in the art. Client application 13 facilitates retrieval of a data model from database 12 via an application program interface (API). The data model comprises a subset of information retrieved from database 12 by way of user specified criteria and typically will be in the form of a set of records or other information items.

Client application 13 of FIG. 1 selects and generates one of the available control objects 11a-11e for rendering a retrieved data model. Rendering refers to displaying information items on screen to a user and providing user facilities to navigate and/or search the information items as well as select one or some of the items. Each control is suited or adapted, by way of its user facilities, to render information of a particular nature, and the selected control is chosen according to the nature of the information which is retrieved. Criteria may be specified to associate the nature of the information with a particular control suited to rendering that type of information.

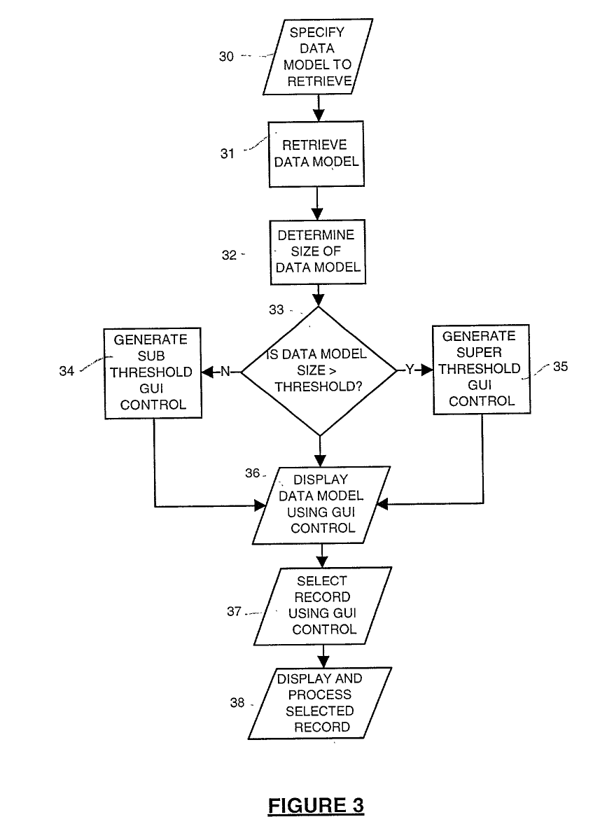

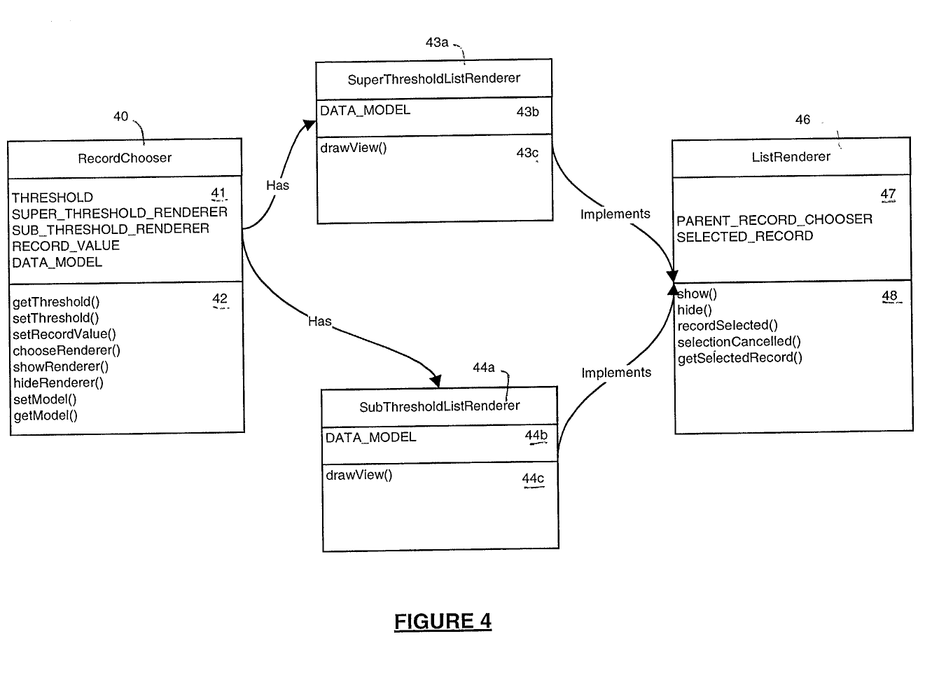

FIG. 3 shows a process implemented by the client application 13 for selecting and creating a control in a preferred embodiment of the invention. This embodiment includes a GUI generator 14 for creating a record chooser 18 control along with just two GUI controls, e.g., 11a, 11b (to be described in detail with reference to FIGS. 4, 5 and 7) implemented using, for example, JAVA™. The first GUI control 11a is suited for rendering a small data model and the second GUI control 11b is suitable for rendering a larger data model. In this embodiment the nature of the information refers to the size of the data model which in turn is related to the number of records or information items retrieved from the database.

In the first step of the process shown in FIG. 3 the user specifies criteria 30 for retrieving a data model. The data model criteria can be specified in any suitable manner such as a SQL or PCML query. Upon submitting a query the client application 13 retrieves information 31 from the database 12 which meets the criteria. The data model is then created from the retrieved information, the data model preferably being implemented as a JAVA™ vector class. It will be appreciated that the client application 13 means for specifying criteria and retrieving information from the database will be well known to those skilled in database design and need not be explained in detail. Such means are independent from the GUI controls which render the data model.

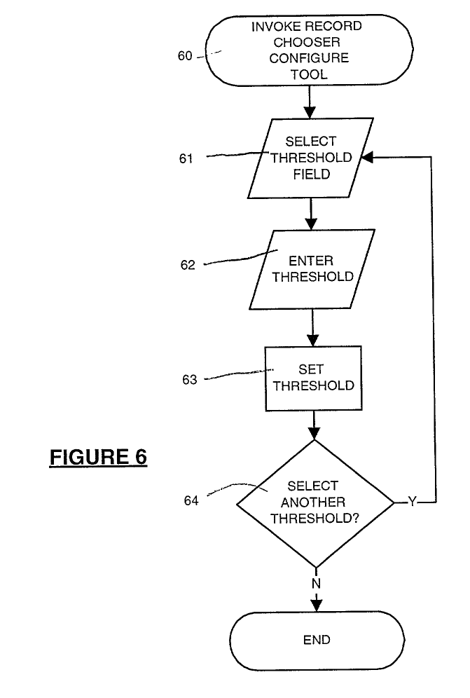

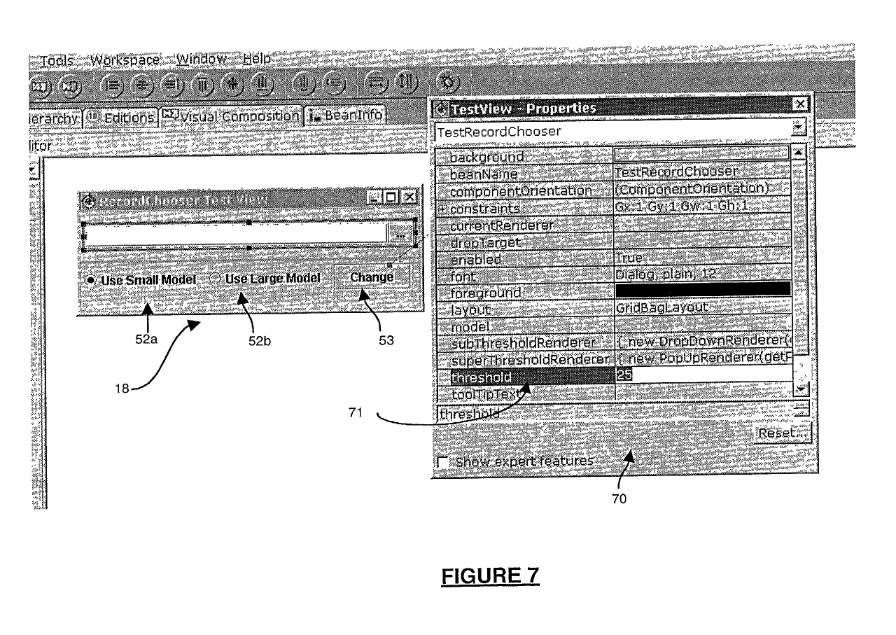

The next step of the process shown in FIG. 3 is to determine the size of the data model 32. Preferably the data model comprises a set of records or other information items which populate the data model vector class, the size of the data model referring to the number of records in the set. The data model is passed to the record chooser control 18 which implements a standard JAVA™ listener interface to detect when the vector class contents change. When the contents change, indicating that the vector class has been populated with information from a new query, the number of records is determined and compared 33 to a threshold value. Details of the threshold and how it is specified will be described with reference to FIGS. 6 and 7. If the number of records in the data model does not exceed the threshold 34 then the GUI generator 14 creates the first control 11a, also called a sub threshold control, for rendering the data model. Otherwise if the number of records in the data model exceeds the threshold value 35 the GUI generator creates the second, or super threshold, control 11b.

The data model is then rendered 36 using the created control at which point the user can select 37 a desired record from the data model by using the control. To assist in selection 37 of a record the control may also be adapted to provide navigation, search and selection facilities as required. The selected record is then passed to the record chooser control 18 and displayed 38 for subsequent use. The facilities provided by the chosen control will be determined at design time based upon the nature of the data model the control will be rendering. The different features or facilities provided by a particular control will make that control more suited to rendering a particular data model than other controls with different features.

The GUI controls 11a, 11b (or more generally controls 11a-11e shown in FIG. 1) are instances of classes used in object oriented programming and can be adapted to provide the functionality required to enable a user to access a retrieved data model. FIG. 4 shows a preferred class structure for the controls created by the GUI generator 14. The RecordChooser class 40 includes variables 41 to store a data model, a threshold value or values, and the number of records in the data model. It further includes variables for specifying the super and sub threshold renderers. The RecordChooser class 40 includes methods 42 for getting and setting the threshold value, getting and setting the data model, setting a record value, and choosing and displaying a renderer. The RecordChooser class 40 has subclasses, SuperThresholdListRenderer 43a and SubThresholdListRenderer 44a, both of which have a data model variable 43b, 44b and a method 43c, 44c for rendering the data model. Both the classes implement an instance of the ListRenderer class 46 which includes variables 47 for indicating the parent record chooser and the selected record. The ListRenderer class 46 also includes methods 48 for displaying/hiding data model records, selecting a record, retrieving a selected record and cancelling a selection.

Instances of the classes shown in FIG. 4 are declared and once a vector class has been populated with information from a query, the data model is passed to the instance of the RecordChooser class 40. The record chooser 18 instance determines the quantity of records in the data model and compares this with the specified threshold. If the quantity is less than the threshold then the record chooser 18 passes the data model to the instance, i.e., the first control 11a, of the SubThresholdListRenderer class 44a which renders the data model by implementing an instance of the ListRender class 46. Alternatively if the quantity is equal to or greater than the threshold, the data model is passed to the instance, i.e., the second control 11b, of the SuperThresholdListRender class 43a which renders the data model by way of the ListRenderer.

The features of each control will be suited to displaying and providing navigation/searching/selection facilities for a data model with a particular quantity or quantity range of records. For example, the sub threshold renderer control 11a might be suited to rendering a set of records with less than 15 items and the super threshold renderer control 11b might be suited to rendering a set of records with 15 or more items. Therefore, if an SQL query retrieves 100 records, then the records will be rendered using the super threshold control 11b, however, if only 12 records are retrieved these will be rendered using the sub threshold control 11a. The suitability of a control to render a data model of a certain size will be dependent on various factors such as whether the control has features which enable convenient manipulation of the displayed records, whether the control is an appropriate size for the available screen space, and whether the control's features enable rendering of the type of information being retrieved. This list is not exhaustive and the database designer may take into account other factors in determining which control should be selected for rendering a particular data model.

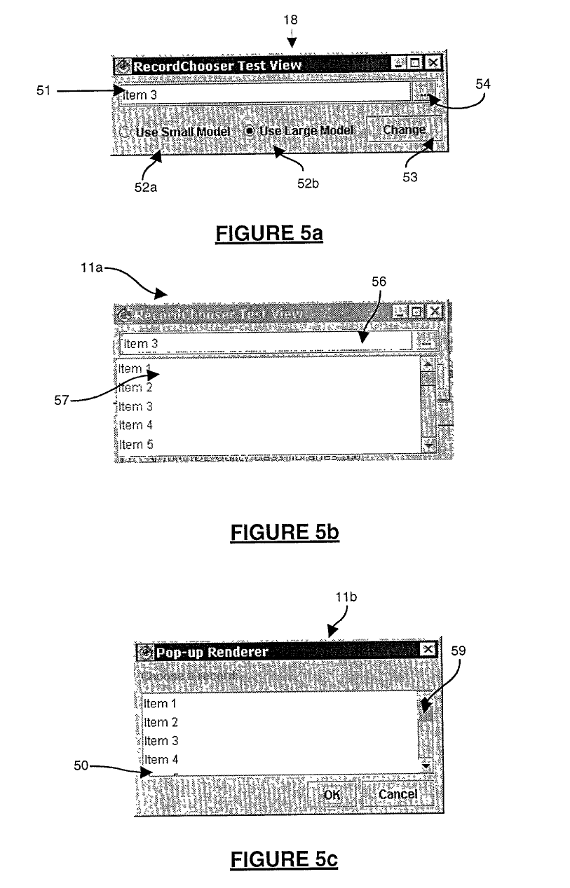

FIGS. 5a-5c illustrate the controls created by the preferred embodiment of the GUI generator 14. For example, FIG. 5a shows the record chooser control 18 of a preferred embodiment which is adapted to display one record from a data model. It includes a display field 51 showing a selected item from the data model and an expand button 54 for viewing the full data model. The control also includes the usual resizing and close down facilities usually provided with a control of this nature. The record chooser control 18 depicted in FIG. 5a is a test view control and therefore there are radio buttons 52a, 52b and a change button 53 for configuring the record chooser 18. The function of these buttons 52a, 52b, 53 will be described with reference to FIGS. 6 and 7. While the record chooser 18 could be configured at runtime, preferably configuration will only take place at design time in which case the configuration buttons 52a, 52b, 53 will not be present in the runtime control 18. Upon pressing the expand button 54 the full data model will be displayed in the control created according to the process outlined in FIG. 2.

More particularly, if the data model does not exceed the threshold, a sub threshold GUI control 11a depicted in FIG. 5b is created. This control is a combination box which includes a selection field 56 and window 57 displaying a list of items in the data model. The features of this control are more suited to rendering a data model with a small number of records. Alternatively if the data model exceeds the threshold a super threshold control 11b depicted in FIG. 5c is created. This is a pop up list box which includes a window 50 for displaying items from the data model and a scroll bar 59 for navigating through the list of items. This control is suited to rendering a larger number of records. In either control 11a, 11b, an item to be displayed in the record chooser 18 is selected by clicking on the desired item in the window 50, 57. It will be appreciated these controls are by way of example only and any suitable controls, either custom made or standard, could be designed as the sub and super threshold renderers 11a, 11b.

A method of setting the threshold value is outlined in FIG. 6 with reference to the record chooser 18 and configure tool 70 depicted in FIG. 7. Preferably configuring the threshold is performed at design time although it will be appreciated that the client application 13 could be adapted to enable configuration of the threshold at runtime by a user. During design of the GUI generator 14 the designer invokes 60 the record chooser configure tool 70 by clicking on the change button 53. A pop up window is displayed showing configuration fields, including a threshold field 71, relating to the record chooser 18. The threshold field 71 can then be selected 61 and an appropriate threshold value, e.g., 25 typed in the field 62 at which point the threshold is set 63.

The threshold value will preferably correspond to a quantity of records in a retrieved data model. Any data model which contains less records than the threshold will be rendered using the sub threshold renderer 11a and any data model with more records than the threshold will be rendered using the super threshold renderer 11b. The designer will use their expertise of GUI controls to determine what an appropriate threshold value will be to ensure that a suitable control is created for rendering any particular data model. The chosen threshold value will be dependent on the type of rendering controls being implemented and the suitability of their features to render data models of particular sizes. The designer may employ any suitable controls or adapt existing control types to include features to make each control suitable for rendering a data model with a particular nature. In a preferred embodiment, any control which can accept a JAVA™ vector class as a data model could be used.

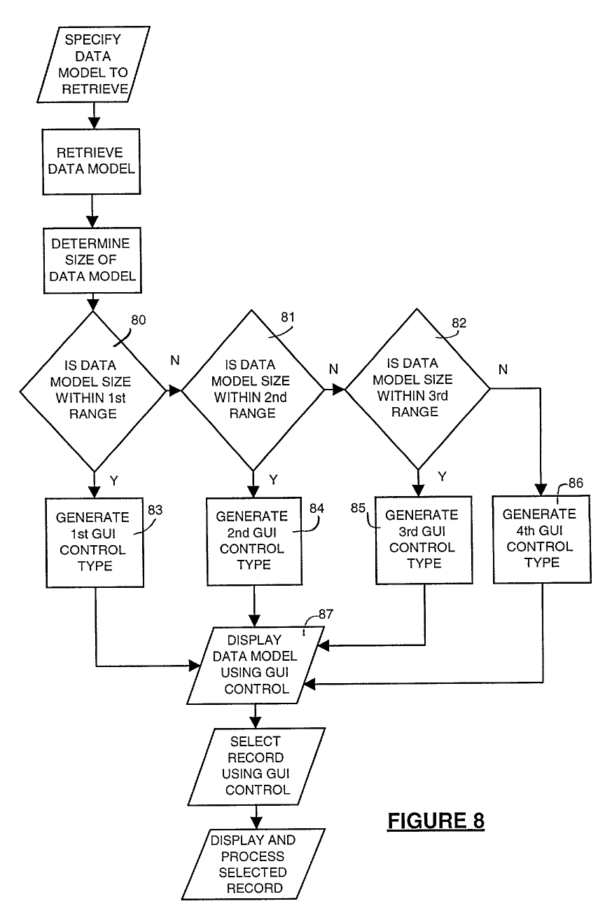

For example, as shown in FIG. 7 the designer decided the sub threshold control 11a is suited to rendering data models with less than 25 records, otherwise the super threshold renderer 11b is more appropriate. In another embodiment (to be described with reference to FIG. 8), multiple thresholds can be specified in which case a second or subsequent threshold field can be selected 64 and configured accordingly. Once all threshold values have been specified, the record chooser configure tool 70 can be closed. In addition, the configure tool 70 can also be used to specify other parameters of the record chooser, for example, the type of controls to be used as the sub and super threshold renderers. The record chooser 18 can also be used to select a test data model by way of buttons 52a, 52b.

While the preferred embodiment described above has two GUI controls 11a, 11b, a larger number of controls could be implemented as outlined in FIG. 8. In this embodiment, each control is suited to rendering a data model with a number of records which falls within a particular range. For example, there may be four GUI controls, the first with features suited to rendering data models with 1-20 records, the second with features for rendering data models with 21-50 records, the third with features for rendering data models with 51-100 records and the fourth with features for rendering data models with 100+ records. These ranges can be specified by setting multiple thresholds as outlined in FIG. 6, each threshold relating to an upper or lower limit of a range. The data model is retrieved and its size determined as set out in FIG. 2.

Referring back to FIG. 8, if the quantity of records in the data model falls within the first range 80, i.e., 1-20 records, then the first GUI control type is created 83. If the quantity of records falls within the second or third ranges 81 or 82, then the second or third GUI control type is generated 84 or 85 as appropriate. Otherwise the fourth control type is generated 86. The data model is then rendered using the selected control 87. It will be appreciated that while four GUI controls are described in this embodiment, in practice any suitable number of GUI controls could be implemented each being suited for rendering a different sized data model. It will also be appreciated that the criteria for selecting a control need not necessarily relate to the number of records in a retrieved data model. A control may be selected on other specified criteria depending on the nature of data model, for example, the size of each individual record, or the format or type of information which is retrieved.

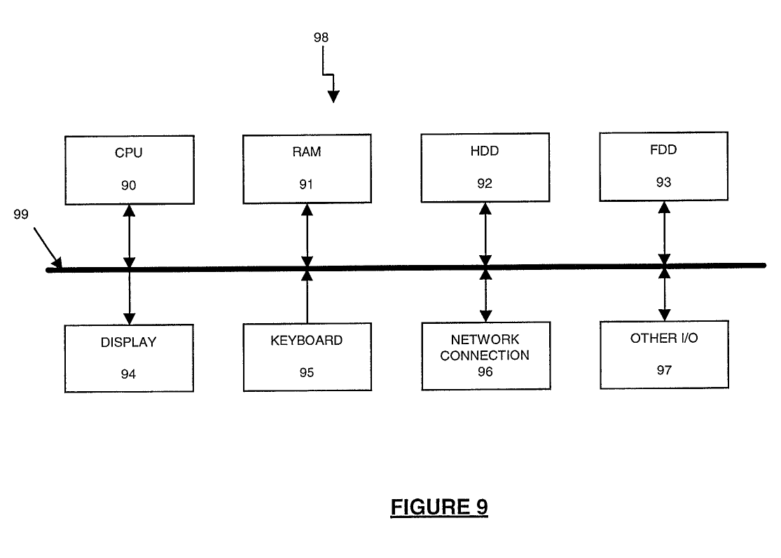

FIG. 9 shows an example of a computer system 98 for implementing the invention. The system 98 includes a databus 99 which interconnects a CPU 90, RAM 91, monitor or other display 94, keyboard 95, network connection 96 and other input/output 97 components. The system 98 has a storage device such as a hard disk drive 92 for storing information and/or computer code as required. The system 98 also includes reading devices for a computer readable medium such as a floppy disk drive 93, CDROM drive or any other device which will be known to those skilled in the art. The client application 13 code can be stored on floppy disk, CDROM or other suitable computer readable medium for loading into the system's RAM 91 or onto the hard drive 92 as required.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A method of presenting a control on a computer user interface comprising:
retrieving stored information on request by a user;
selecting a control according to the nature of the information; and
creating the control on the interface including the information.

2. A method according to claim 1, wherein the control is selected from two or more control types according to the nature of the information.

3. A method according to claim 2, wherein each control is suited for use with information of a particular nature.

4. A method according to claim 3, wherein the information comprises a plurality of records and the nature of the information relates to the number of records.

5. A method according to claim 4, wherein the control is selected according to the number of records comprising the information.

6. A method according to claim 5, wherein the selected control is suited for displaying the number of records comprising the information.

7. A method according to claim 4, wherein the control is selected according to a threshold which relates to a quantity of records.

8. A method according to claim 7, wherein the selected control is suited to displaying the number of records comprising the information.

9. A method according to claim 8, wherein the control is a combination box or a list box.

10. A computer program product comprising a computer useable medium having computer readable program code embodied therein for presenting a control on a computer user interface, the computer program product comprising:
program code configured to retrieve information requested by a user;
program code configured to select a control according to the nature of the information; and
program code configured to create the control on the interface including the information.

11. A computer program product according to claim 10, wherein the selection program code selects the control from two or more control types according to the nature of the information.

12. A computer program product according to claim 11, wherein each control is suited for use with information of a particular nature.

13. A computer program product according to claim 12, wherein the information comprises a plurality of records and the nature of the information relates to the number of records.

14. A computer program product according to claim 13, wherein the selection program code selects the control according to the number of records comprising the information.

15. A computer program product according to claim 14, wherein the selected control is suited to displaying the number of records comprising the information.

16. A computer program product according to claim 15, wherein the control is a combination box or a list box.

17. A computer program product according to claim 13, wherein the selection program code selects the control according to a threshold which relates to a quantity of records.

18. A computer program product according to claim 17, wherein the selected control is suited to displaying the number of records comprising the information.

19. A computer program product according to claim 18, wherein the control is a combination box or a list box.

20. A system for presenting a control on a computer user interface, the system comprising:
means for retrieving information requested by a user;
means for selecting a control according to the nature of the information; and
means for creating the control on the interface including the information.

21. A system according to claim 20, wherein the means for selecting is adapted to select the control from two or more control types according to the nature of the information.

22. A system according to claim 21, wherein each control is suited for use with information of a particular nature.

23. A system according to claim 22, wherein the information comprises a plurality of records and the nature of the information relates to the number of records.

24. A system according to claim 23, wherein the means for selecting is adapted to select the control according to the number of records comprising the information.

25. A system according to claim 24, wherein the selected control is suited to displaying the number of records comprising the information.

26. A system according to claim 25, wherein the control is a combination box or a list box.

27. A system according to claim 23, wherein the means for selecting is adapted to select the control according to a threshold which relates to a quantity of records.

28. A system according to claim 27, wherein the selected control is suited to displaying the number of records comprising the information.

29. A system according to claim 28, wherein the control is a combination box or a list box.
